(19) United States
(12) Patent Application Publication
(10) Pub. No.: US 2019/0114870 A1
(43) Pub. Date: Apr. 18, 2019

(54) Printed or electronic scratch-off game combined with a greeting card, postcard, electronic message or eCard. The receiver (player) reveals a pre-seleted message from the giver (sender) of the game or wins a pre-selected gift or pre-selected action that the giver (sender) of the game has pre-selected to give the receiver or do for the receiver.

(71) Applicant: Shelli Perlman, Topeka, KS (US)

(72) Inventor: Shelli Perlman, Topeka, KS (US)

(21) Appl. No.: 15/783,377

(22) Filed: Oct. 13, 2017

(51) Int. Cl. G07F 17/32; A63F 3/06; B42D 15/04

(52) U.S. Cl. CPC G07F 17/329; B42D 15/042; A63F 3/0665

(57) ABSTRACT

This invention is in the field of greeting cards, social expression and entertainment products in combination with instant scratch-off games, more particularly a greeting card or eCard with a scratch off game where the person wins something; in this case a pre-selected or non pre-selected gift or a surprise written message from the person who gave or sent the receiver the card or eCard. For many years paper greeting cards and eCards containing text sentiment and associated artwork have been widely used for celebratory occasions. Additionally, for decades “Scratch-off instant-win” tickets and online scratch off games have been enjoyed with immense popularity. This is a combination of both. The giver of the card can pre-select the gift they want to give the receiver, leave the gift a surprise or pre-select a message they want say. They receiver scratches the card to reveal the gift or message from the giver.

### FIELD OF INVENTION

This invention is in the field of entertainment, greeting cards and social expression products in combination with instant scratch-off lottery games, more particularly a greeting card or eCard with a scratch off game where the person wins something; in this case a gift or a surprise message or surprise item from the person who gave or sent the receiver the card or eCard.

### BACKGROUND

For many years paper greeting cards and eCards containing text sentiment and associated artwork have been widely used for celebratory occasions such as birthdays, love, anniversaries, graduations, weddings, and for other commercial purposes. Additionally, for decades “Scratch-off” or “instant-win” lottery tickets and online scratch off games have been enjoyed with immense popularity. This is a combination of a non-financial lottery game and a card, greeting card or an eCard where the receiver wins a pre-selected gift, a surprise gift or a surprise message from the sender of the card or eCard. The giver of the card can pre-select the gift or message the receiver will reveal when playing the scratch off game on the card or eCard. The giver of the card can also leave the gift or message a surprise for them as well so that both giver and receiver don't know what they will get or have to give.

### SUMMARY OF INVENTION

The present disclosure and related inventions are directed to a greeting card or other social expression product which is combined with a simple scratch-off game whereby the receiver of the card or eCard get a gift, surprise or surprise message from the giver of the card.

The greeting card combines a traditional paper greeting card or eCard and a scratch off game to create a new exciting game where the receiver of the greeting card receives a surprise gift or surprise message from the giver of the greeting card or eCard.

The giver of the card is able to choose the item they want to give to the receiver of the card from a list that is provided when choosing the card. The giver, on some circumstances when electronic eCards can also add a personal message that will be revealed when the receiver of the card scratches off the material or electronically scratches off the area where the message is.

### DESCRIPTION OF DRAWINGS

FIG. 1 Front view of present invention on a printed greeting card that is wrapped in cellophane bag.

FIG. 2 Front view of present invention on a printed greeting card with a tear off tab.

FIG. 3 A three dimensional view of FIG. 1 when open slightly.

FIG. 4 View of FIG. 3 when the scratch off material is scratched off, revealing the gifts under it.

FIG. 5 Open view of FIG. 1 and FIG. 2 just like any conventional greeting card.

FIG. 6 Back view of FIG. 1 and FIG. 2.

FIG. 7 View of an online list of gifts of present invention when sent electronically.

FIG. 8 An online message, design or animation that can be added to the present invention when sent electronically.

FIG. 9 Sample of the present invention when presented electronically.

FIG. 10 Sample of how the icons look like when scratched electronically (using finger or mouse.) FIG. 11 View of FIG. 1 with a different shape and a surprise message instead of a gift.

FIG. 12 View of FIG. 11 when material is scratched off, revealing the written message.

FIG. 13 View of FIG. 2 with a different shape and a surprise message instead of gift.

FIG. 14 FIG. 1 and FIG. 11 showing how there can be different designs, messages, shapes of scratch off material.

FIG. 15 FIG. 2 and FIG. 13 showing how there can be different designs, messages, shapes of scratch off material.

FIG. 16 View of tear off tab from FIG. 2 when removed from card.

FIG. 17 Side view of FIG. 1 when slightly open.

FIG. 18 Side view of FIG. 1 when it is only a postcard or a one panel card.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

The idea is utilizing the conventional greeting card combined with a scratch off game where the receiver has to scratch off all the scratch off material on a printed greeting card and reveal what gift they win or secret message they get from the giver (buyer or sender) of the card. The present disclosure also includes an explanation of how this concept of a greeting with a scratch off game can be designed and utilized electronically online via social media, facebook messaging, email or text.

The present invention is a scratch off game which wins the receiver a pre-selected gift, a surprise or message from the person who gave the receiver the present invention. It is combined with a greeting card, a post card, a card or an electronic message or interactive animated message.

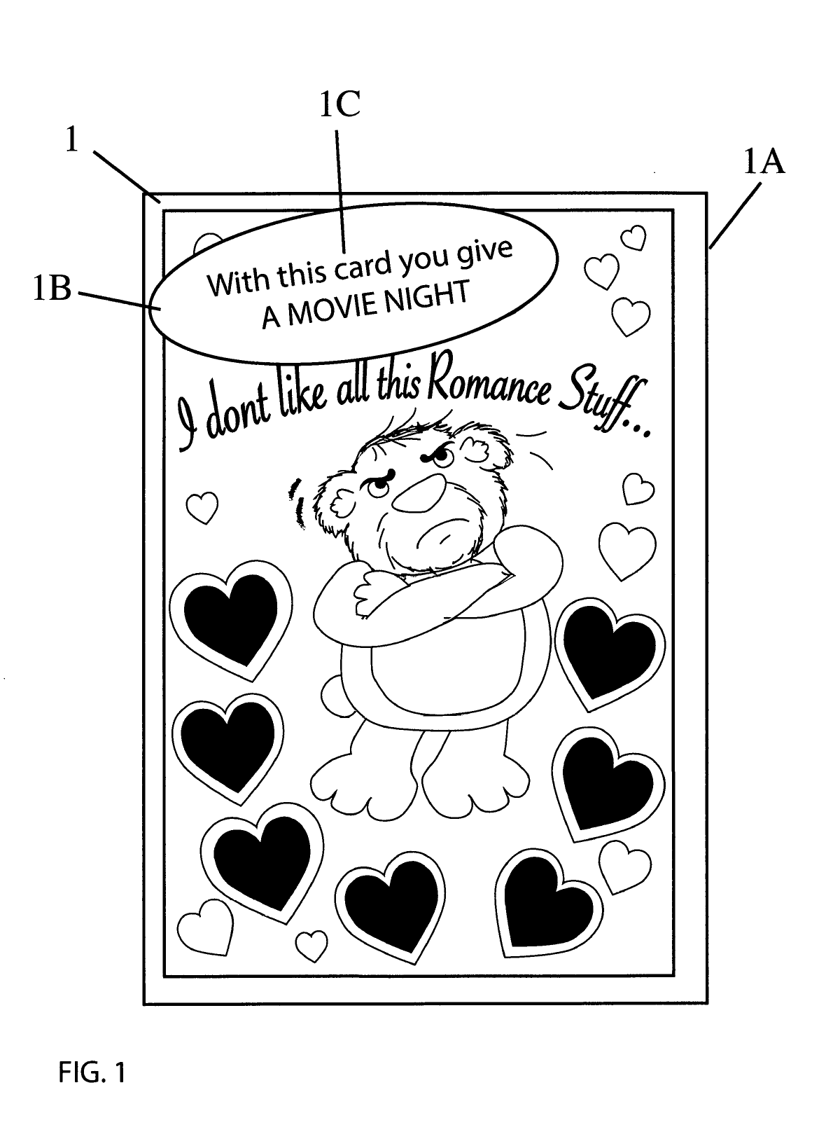

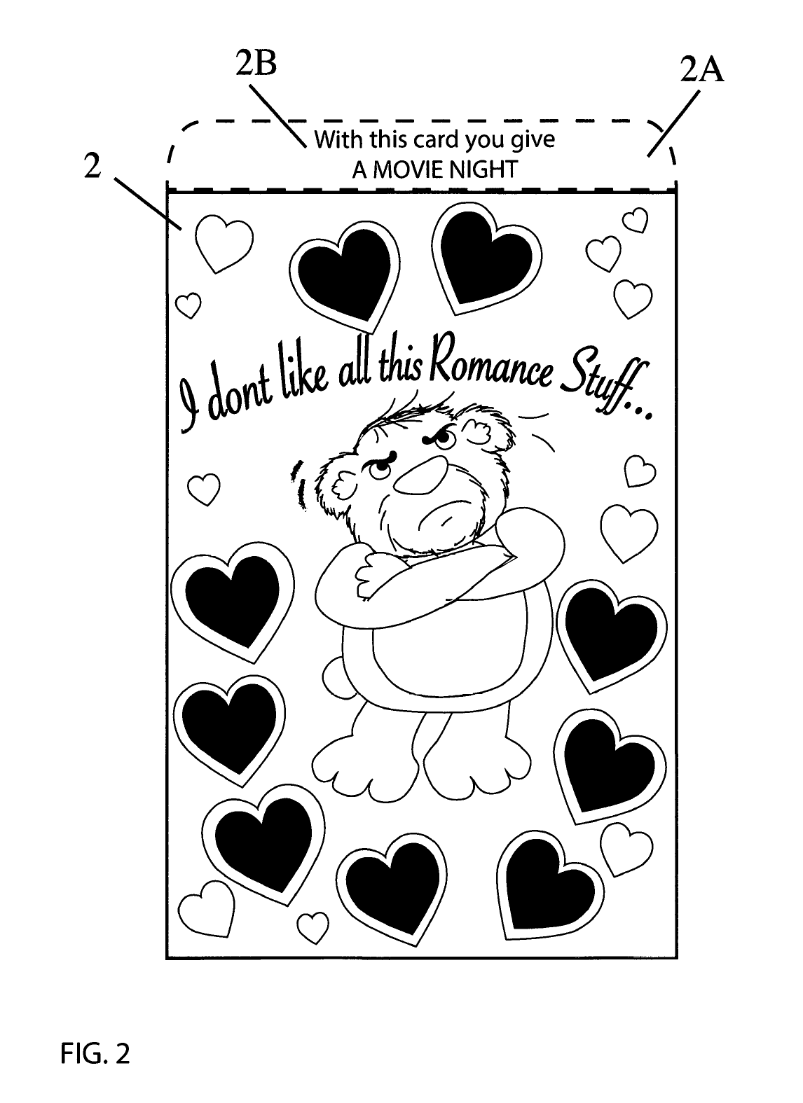

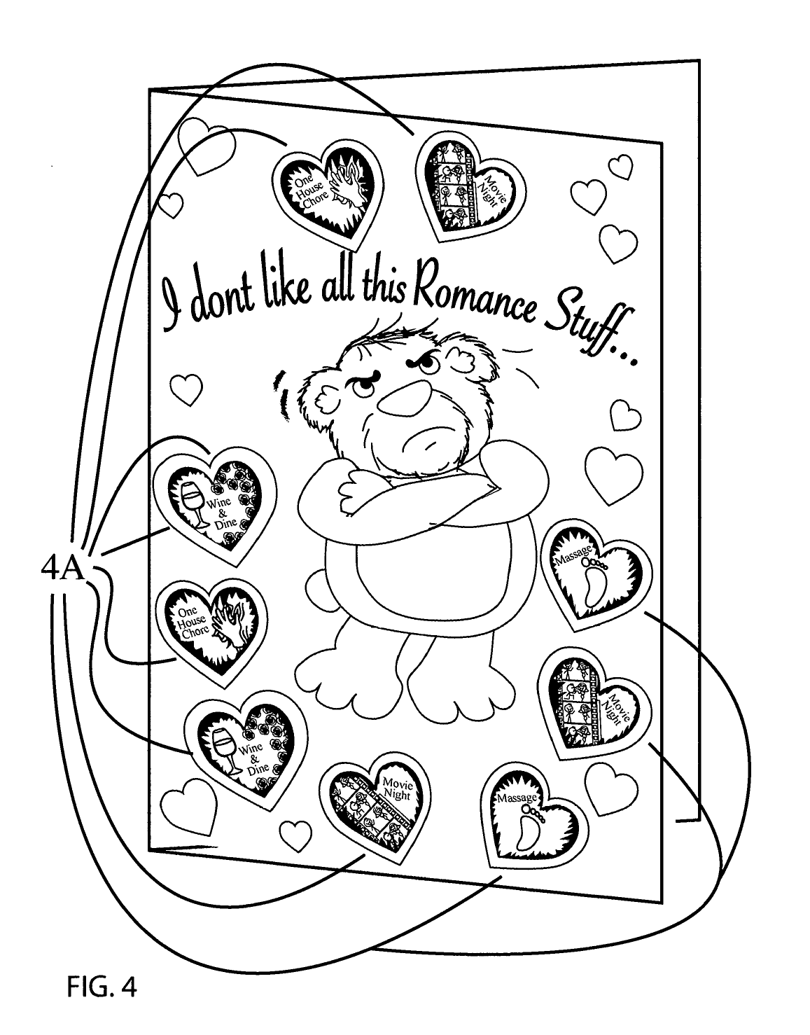

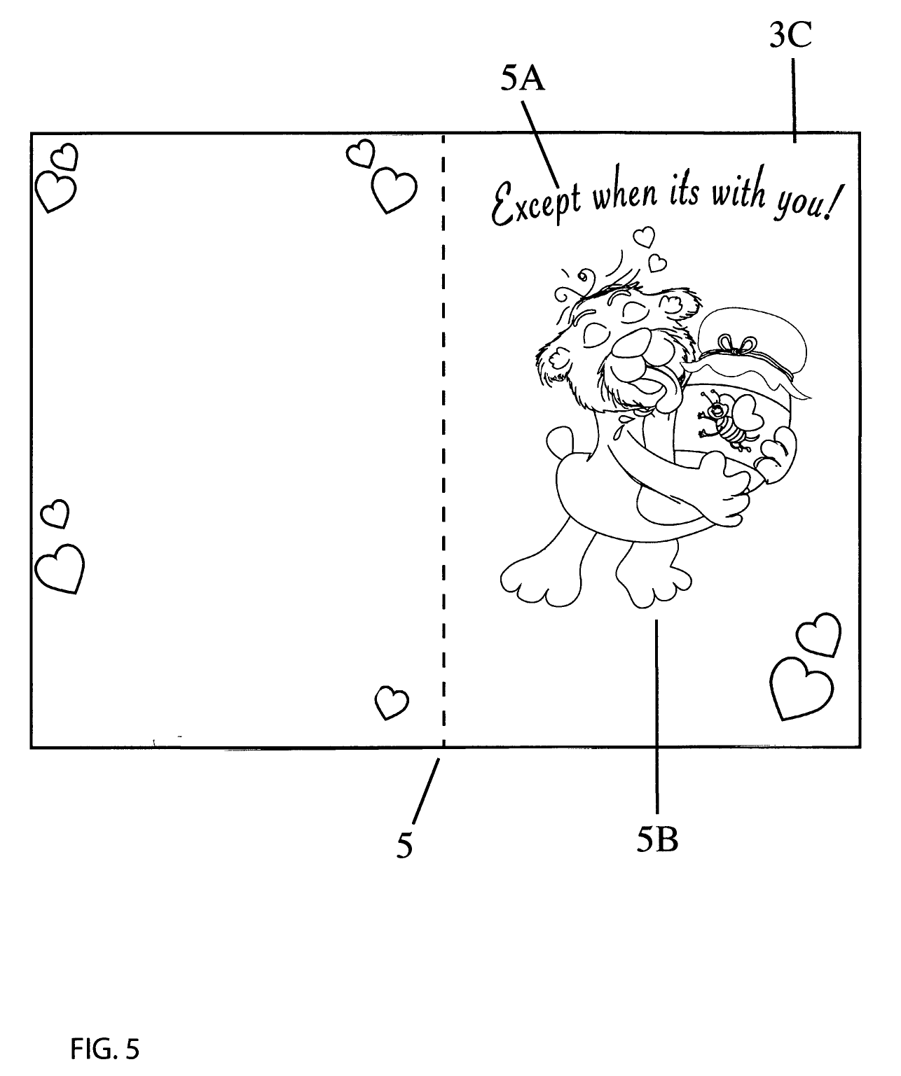

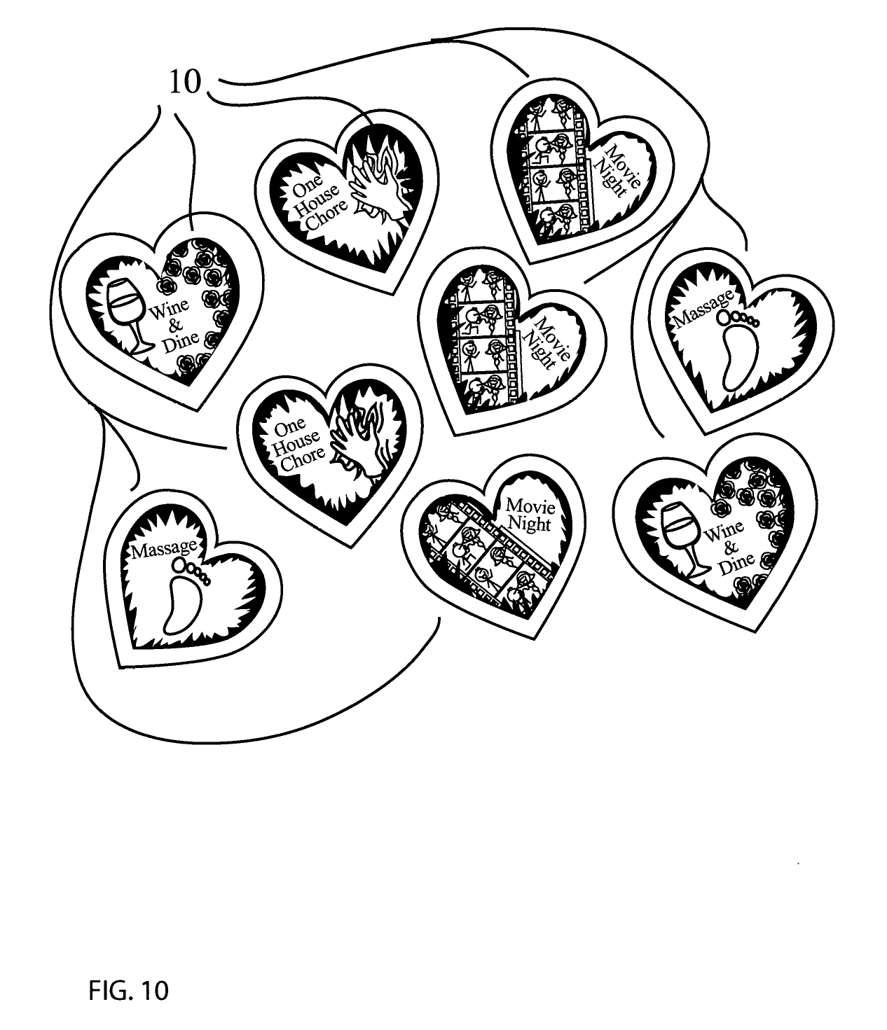

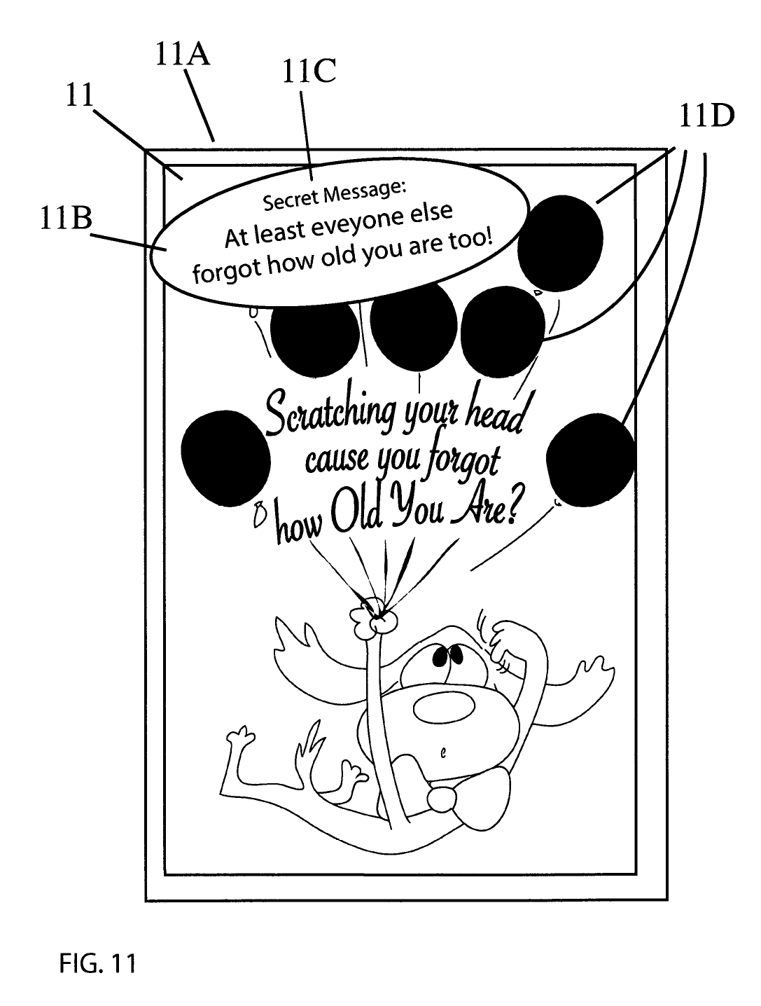

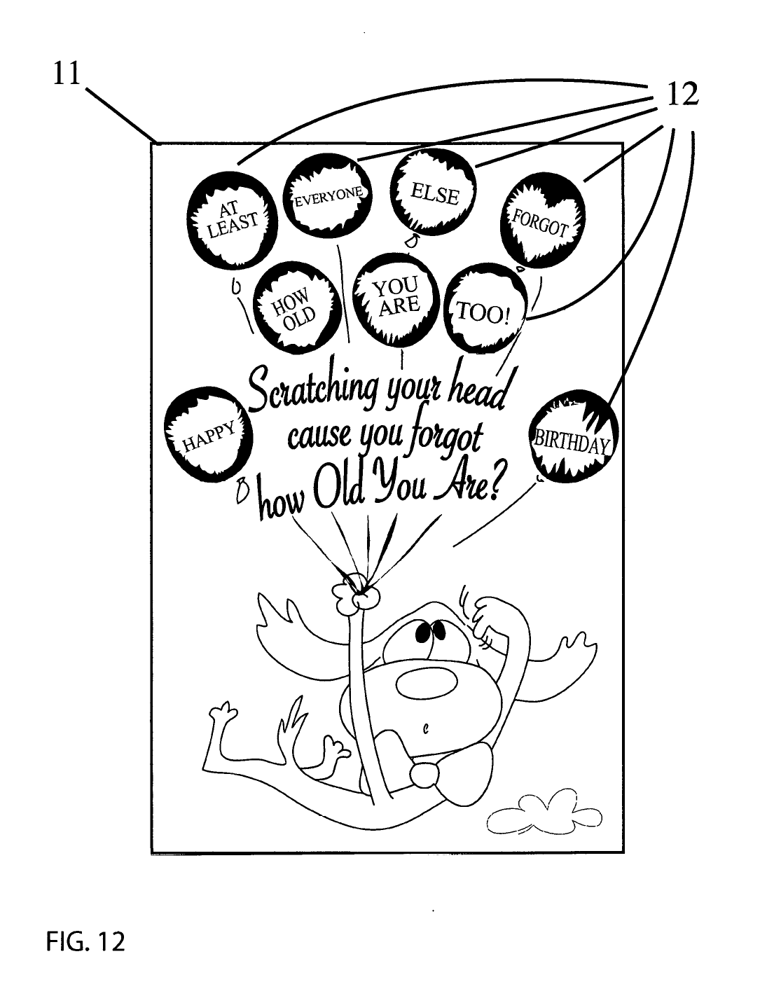

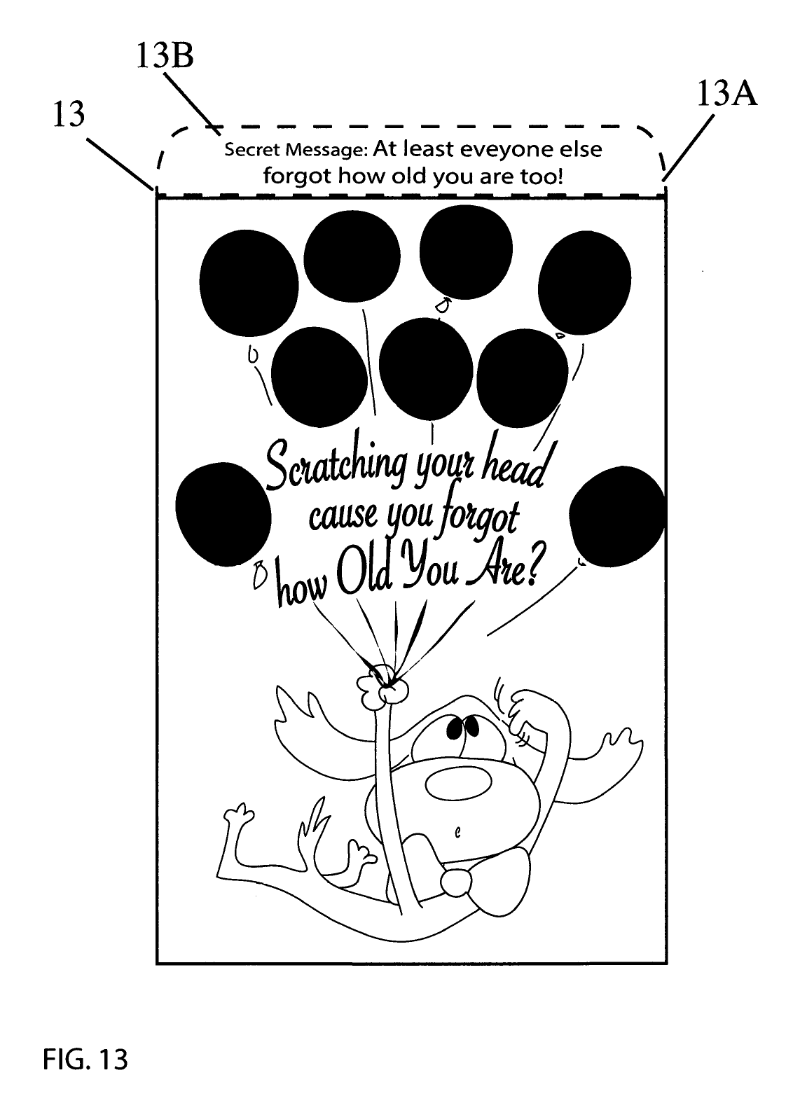

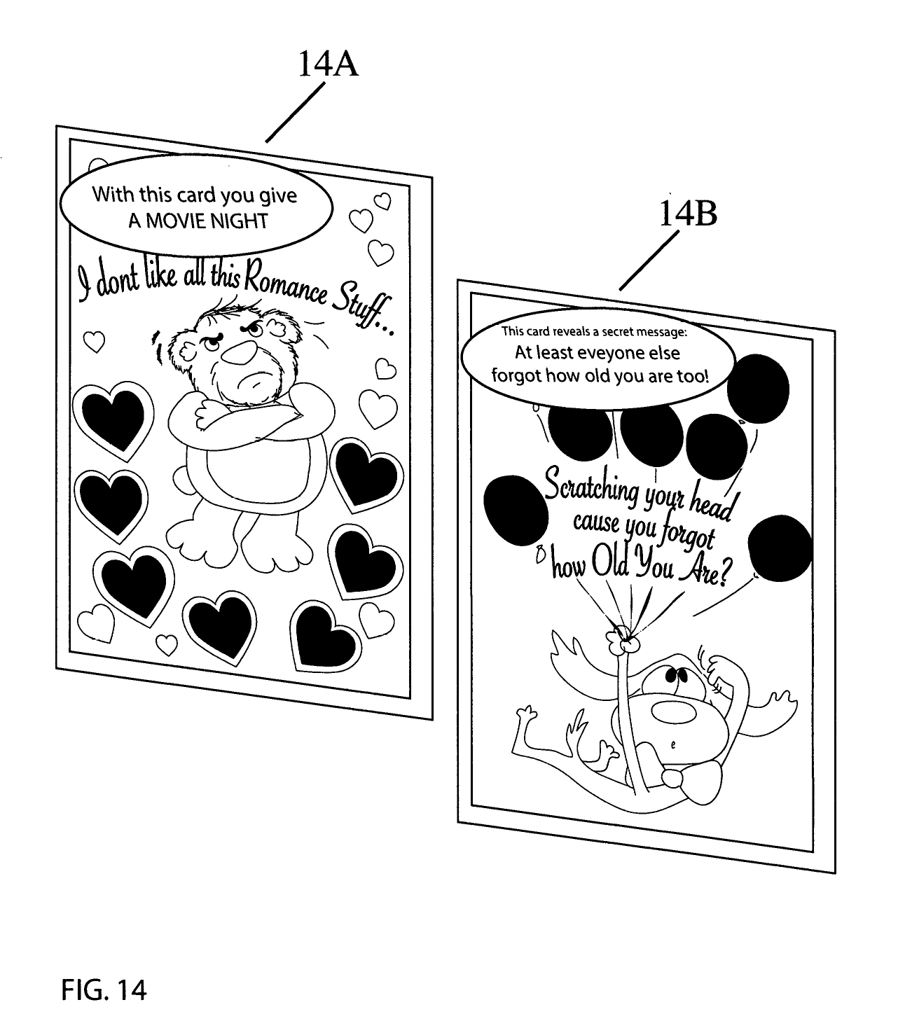

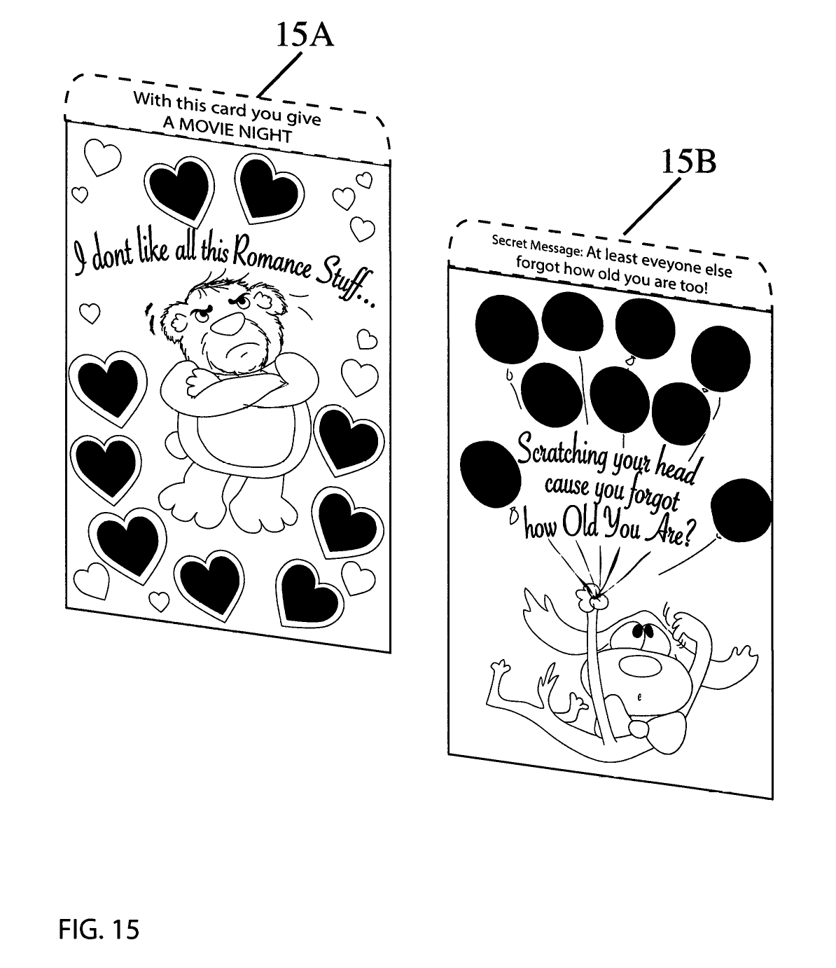

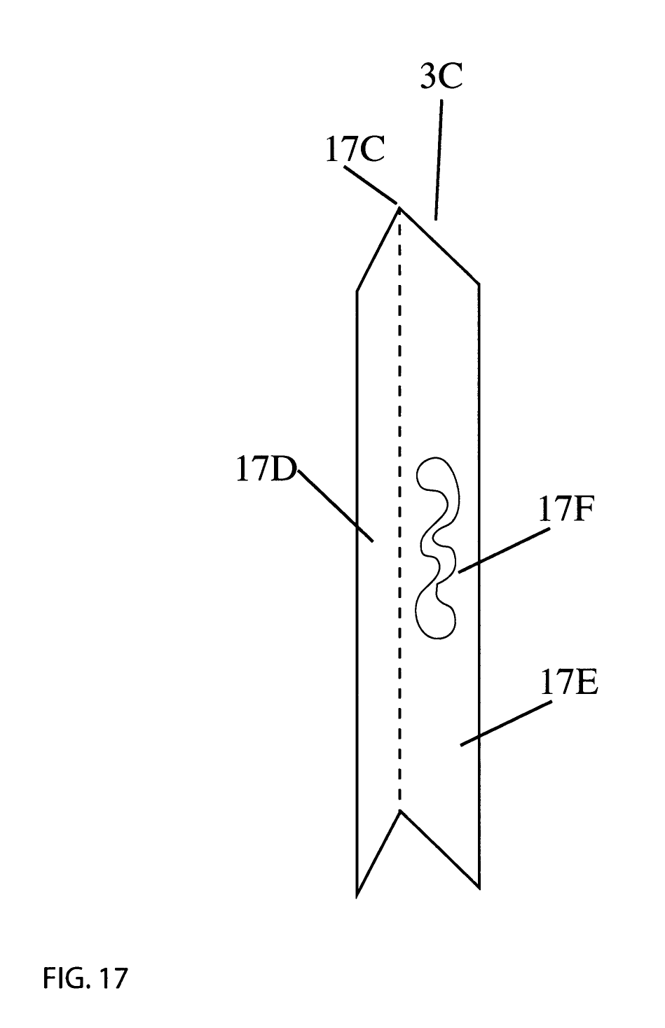

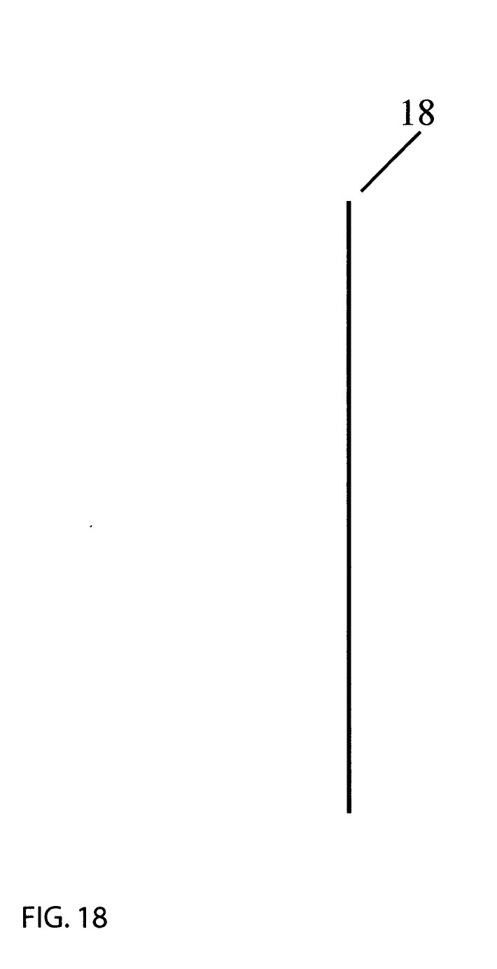

In a first embodiment, shown in FIGS. 1 through 18, the present invention is a conventional greeting card (1) which is inserted, with or without an envelope, into a cellophane bag (1A) and optionally sealed. The greeting card is just like any other greeting card that has a message (3) and a design (3A) on the front of the card and an optional message (5A) and design (5B) on the inside of the card [(3C) on FIG. 3, FIG. 5. and FIG. 17] This message and design are optional and can be varied in every way, as does a typical greeting card. The greeting card can open up (5) and fold back up (17C) so that it has a front panel (17D) and a back panel (17E) with a design on it (17F). This is optional because it can also be a one sided card, similar to a postcard with only one panel (18). Like a typical greeting card (14A) (14B) (15A) (15B) there are different written messages and designs for the buyer to choose from that greet a lover, a friend, a family member, etc. The present invention adds the additional element of a scratch off game [FIG. 3 (3B)] to the traditional greeting card, where the receiver of the card can scratch off the printed film (3B) and reveal a gift or surprise (4A) that the receiver can now get from the giver (buyer or sender) of the card. Optionally, the giver (buyer or sender) of the card can choose a card with a secret message [FIG. 13 (13)] that the receiver will then reveal by scratching off the material [FIG. 12 (12)].

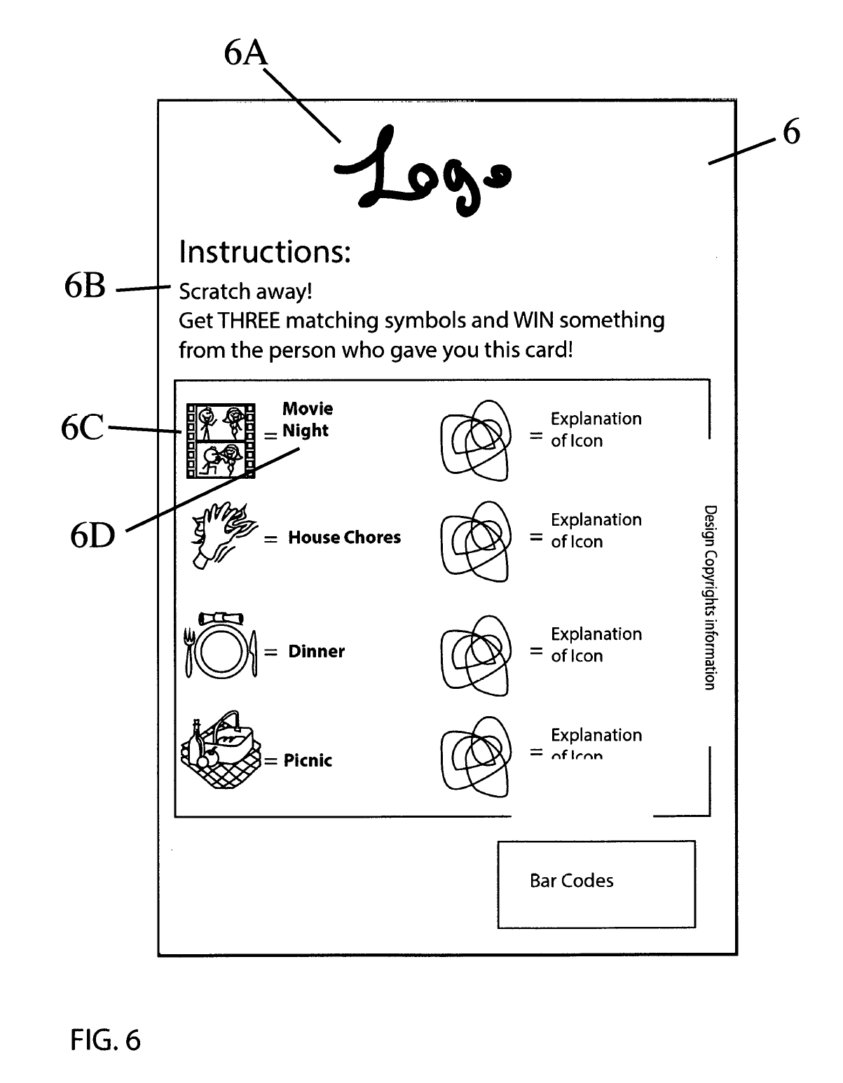

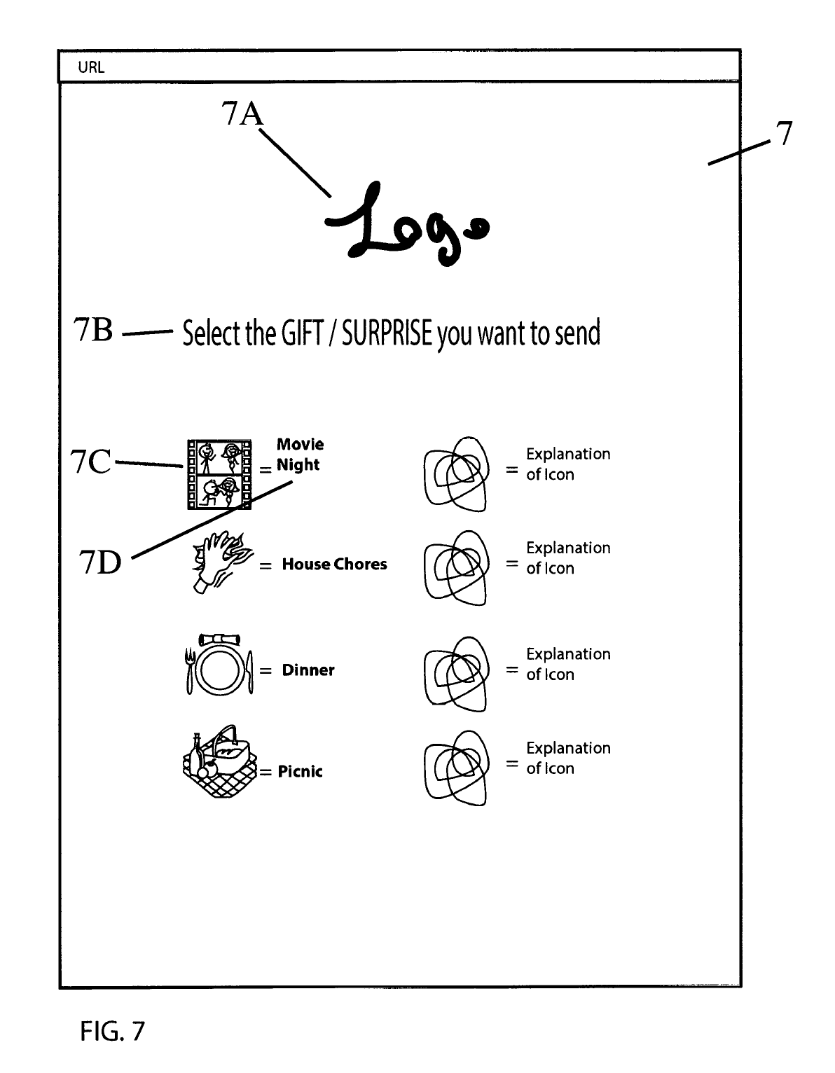

This is not a lottery game whereby the person can or can not win. This is also not a lottery game where one person wins money from a pot that many other people put money into. This is not a lottery game that wins you money, unless it is a pre-selected gift the giver wants to give the receiver of the card. Every scratch off game is a winning game whereby the receiver wins a surprise gift or message that was pre-selected by the person who gave or sent them the card but is not limited to winning. The gift or text can be pre-selected by the giver or the giver can also choose to play it by chance and see what the receiver will win without the giver pre-selecting a gift or text. This is to increase the surprise element for the giver as well as the receiver. That gift can be pre-selected pre-printed by the giver (buyer or sender) from a list FIG. 6 and FIG. 7 which can be on the back of the card (6) or on a banner. The instructions (6B) and list of available gift icons (6C) and their explanations (6D) explain the giver (buyer or sender) the options they have as to gifts they can offer the receiver of the card. Optionally, when going online to send an eCard they will have a list of the items they can offer (7C) with their explanations (7D).

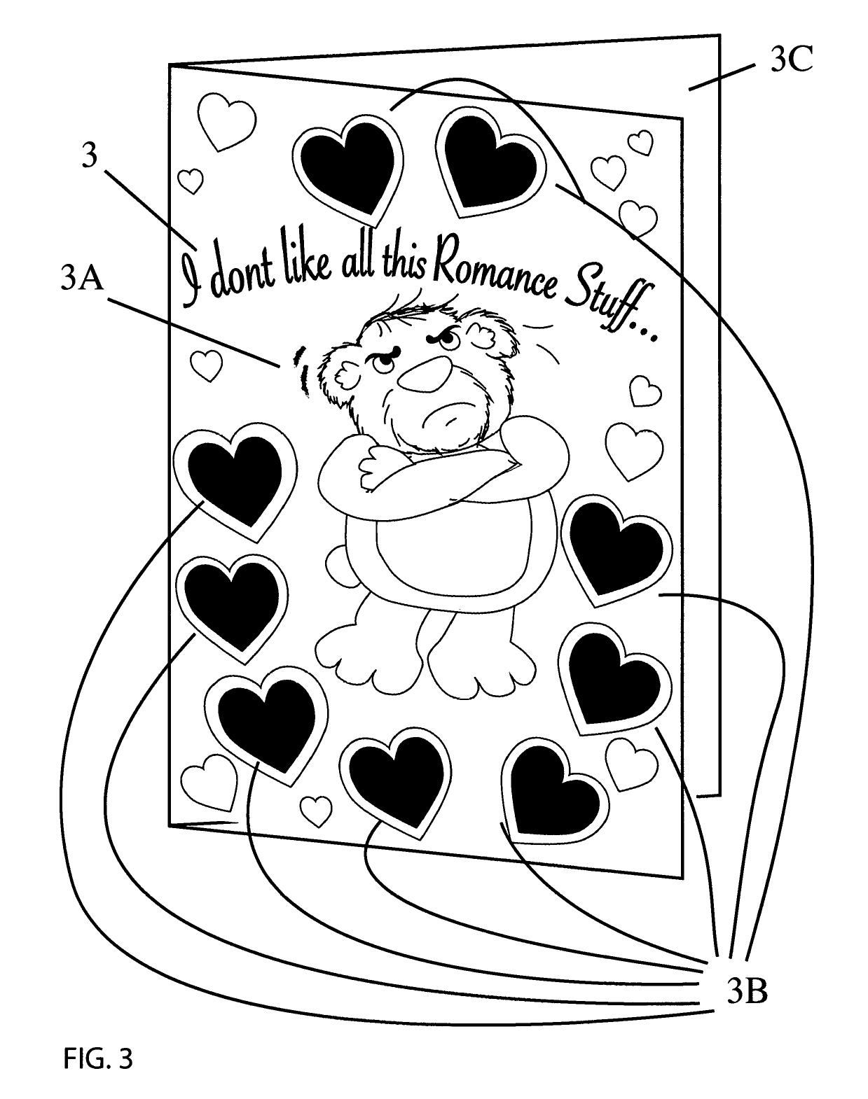

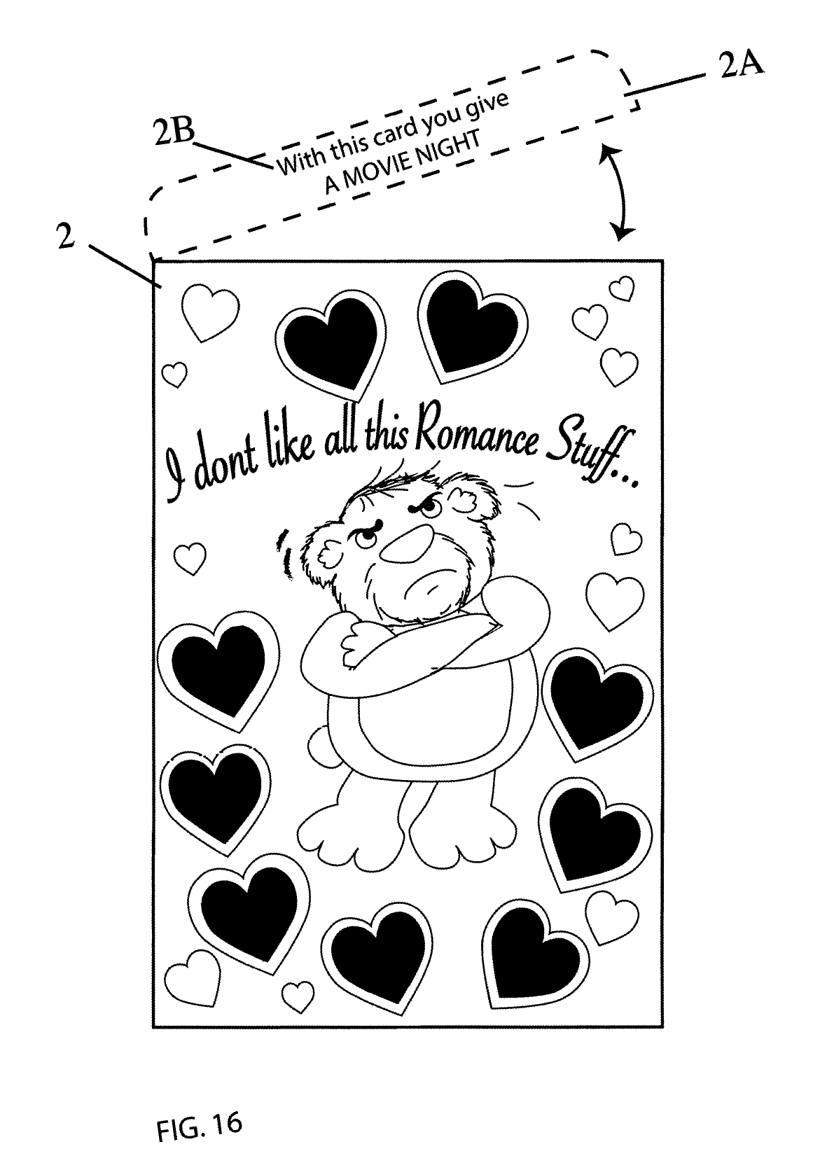

When choosing the present invention, the giver (buyer or sender) can look for the gift or message they want to give the receiver in order to choose the gift or message they want to give. That gift or message that is under the scratch off material (4A) (10) and (12) is pre-revealed solely to the giver (buyer or sender) by being printed on a separate sticker (1B) (11B) that the giver of the card can remove before giving the card to the receiver. It is also optionally revealed on a tear off tab [FIG. 2 (2A)] that the giver can tear off FIG. 16 before giving the card to the receiver. Or is revealed on a list that the giver can go through FIG. 7 and choose so that they can send it to someone as an electronic eCard or facebook message. The nine shapes which are printed on the greeting card with scratch off film (3B) and (13) can be printed in different shapes to match the occasion of the card and can be physically scratched off (4A) (12) to reveal the icon gift or message under them. The number of scratch off shapes are not limited to a certain amount. The instructions (6B) (7B) are also not limited to a specific game. Each series of this present invention can have a different set of game rules with a different set of scratch off design and icons or messages.

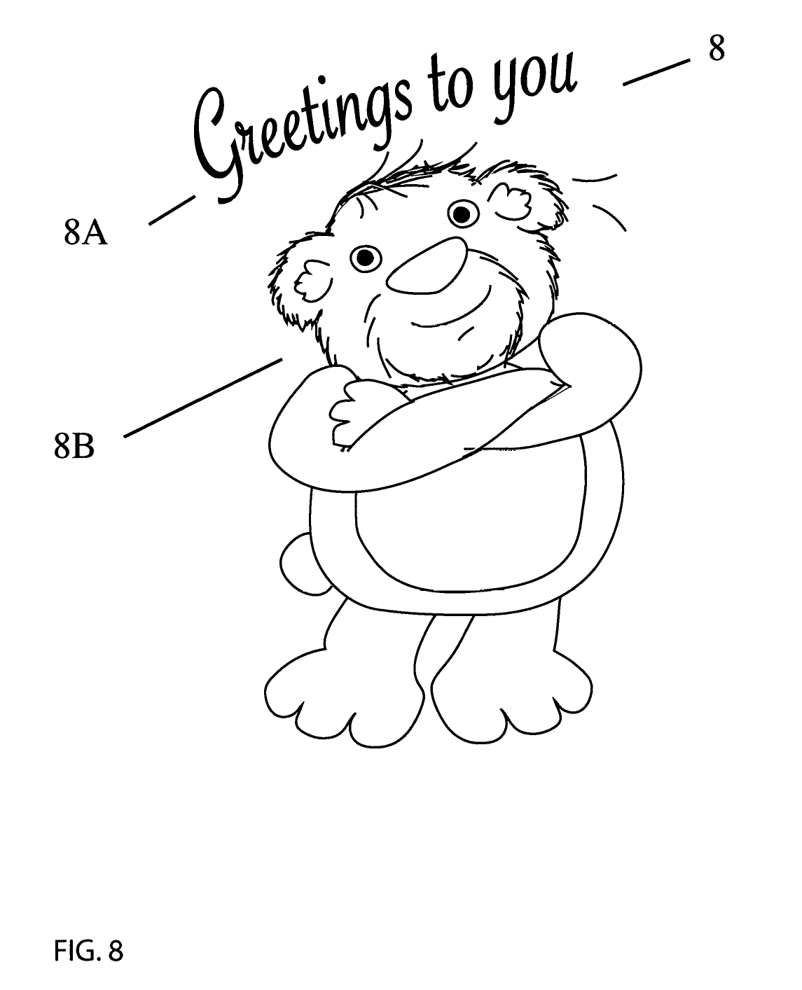

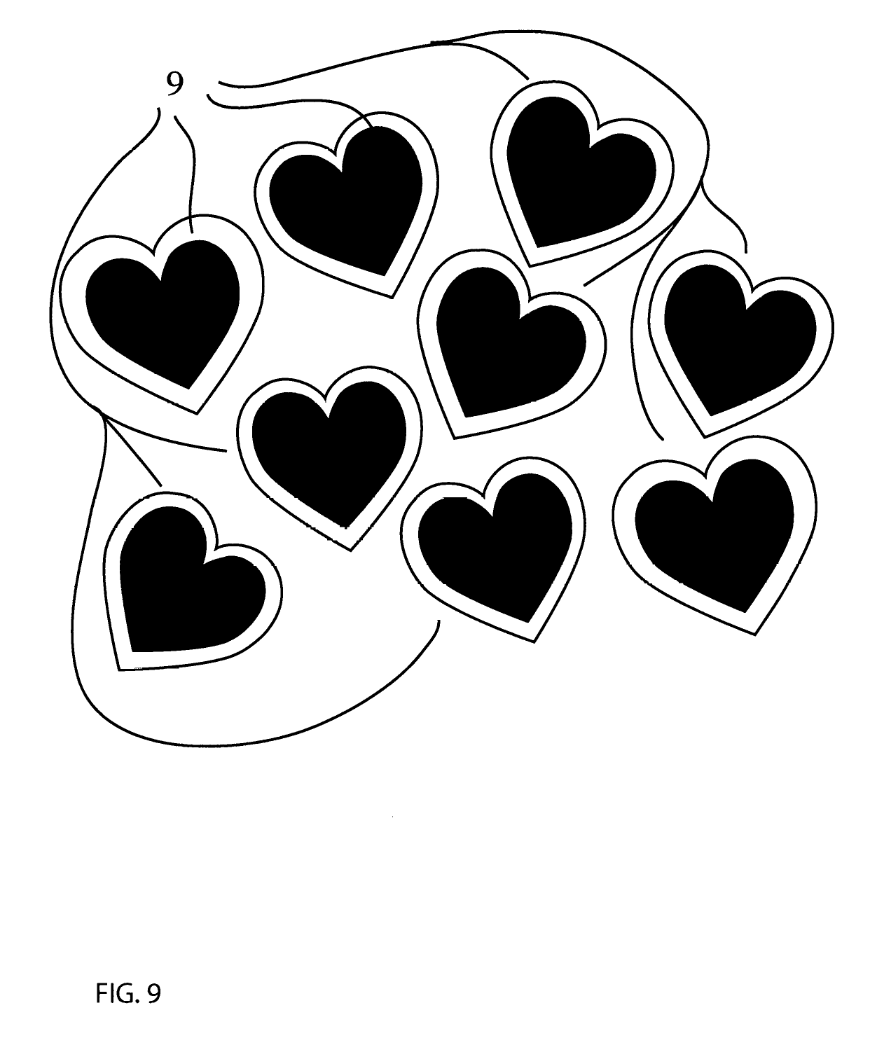

When sending the present invention electronically as an eCard, text or facebook message, the sender of the card can first choose their gift or message FIG. 7 and have an option to also enter a customized gift or message. That sender can also choose a text (8A), a design (8B) or an animation (8) to show or play before the scratch off game (9) begins. The receiver of the present invention will get a customized link via a social media message, text message or eMail. The receiver can automatically view the present invention or click on a link to go view the present invention online in a specific url designated for their message and game. The receiver can then see the greeting FIG. 8 and play the scratch off game (9) by scratching off the concealed areas (10) using their finger on a touch screen device or using their mouse on a computer. The winning gift or message is optionally displayed with an animation or without.

### Mode(S) for Carrying Out the Invention

The present invention can be carried out in printed form on a card, a greeting card, a post card or other printed material that can be given to a person to play and it can be carried out in an electronic form where it can be sent by someone specific to another someone specific to play. The present invention can have pre-selected gifts or words to be sent to the receiver by the sender or it can be a lottery where the sender does not know what the receiver will win from them or get as a message from them, keeping the element of surprise for both receiver and giver.

1. A non-lottery scratch off game that is given, or sent, by a person (giver) to another person (receiver) with the intention of the receiver of the game winning a gift or revealing a message from the giver of the game, comprising of:
a. Instructions
b. At least one play area that can be comprised of one of the following:
i. At least one icon, or more, that stands for a specific pre-selected gift that the giver of the game wants, and chooses, to give the receiver of the game if they win,
ii. At least one word, or more, that comprises a message that the giver of the game wants to tell the receiver of the game.
c. Scratch off material, printed or electronic, that can be removed to reveal the icons or words in point b.

2. The non-lottery scratch off game of claim 1, wherein it is printed on a card that is wrapped in cellophane bag and includes a sticker that reveals the gift icon or text that is printed under the scratch off material.

3. The non-lottery scratch off game of claim 1, wherein it is printed on a greeting card that is wrapped in cellophane bag and includes a sticker that reveals the gift icon or text that is printed under the scratch off material.

4. The non-lottery scratch off game of claim 1, wherein it is printed on a postcard that is wrapped in cellophane bag and includes a sticker that reveals the gift icon or text that is printed under the scratch off material.

5. The non-lottery scratch off game of claim 1, wherein it is printed on a card that has a tear off tab that reveals the gift icon or text that is printed under the scratch off material.

6. The non-lottery scratch off game of claim 1, wherein it is printed on a greeting card that has a tear off tab that reveals the gift icon or text that is printed under the scratch off material.

7. The non-lottery scratch off game of claim 1, wherein it is printed on a postcard that has a tear off tab that reveals the gift icon or text that is printed under the scratch off material.

8. The non-lottery scratch off game of claim 1, wherein it is programmed and designed to be sent electronically by eMail, social media message or text message and be played electronically within the eMail or social media program or text message.

9. The non-lottery scratch off game of claim 1, wherein it is programmed and designed to be sent electronically by eMail, social media message or text message and be played when the receiver clicks and goes to a specific URL.

10. A lottery scratch off game that is given, or sent, by a person (giver) to another person (receiver) with the intention of the receiver of the game winning a gift or revealing a message from the giver of the game that is not pre-selected and is decided by chance, giving both the giver and receiver the element of surprise, comprising of:
a. Instructions
b. At least one play area that can be comprised of one of the following:
i. At least one icon, or more, that stands for a gift that the giver of the game did not pre-select and did not choose but will end up giving the receiver of the card, if they win.
ii. At least one word, or more, that the giver of the game did not pre-select but that will reveal themselves to the receiver of the card weather the giver wants to say those words or not.
c. Scratch off material, printed or electronic, that can be removed to reveal the icons or words in point b.

11. The lottery scratch off game of claim 6, wherein it is printed on a card that is wrapped in a cellophane bag and includes a sticker that reveals more than one option of what could be the pre-printed gift icon or text on the card, surprising both giver and receiver.

12. The lottery scratch off game of claim 6, wherein it is printed on a greeting card that is wrapped in a cellophane bag and includes a sticker that reveals more than one option of what could be the pre-printed gift icon or text on the card, surprising both giver and receiver.

13. The lottery scratch off game of claim 6, wherein it is printed on a postcard that is wrapped in a cellophane bag and includes a sticker that reveals more than one option of what could be the pre-printed gift icon or text on the card, surprising both giver and receiver.

14. The lottery scratch off game of claim 6, wherein it is printed on a card, greeting card or postcard that has a tear off tab that reveals more than one option of what could be the pre-printed gift icon or text on the card, surprising both giver and receiver.

15. The lottery scratch off game of claim 6, wherein it is printed on a card with separate instructions that reveal more than one option of what could be the prc-printed gift icon or text on the card, surprising both giver and receiver.

16. The lottery scratch off game of claim 6, wherein it is printed on a greeting card with separate instructions that reveal more than one option of what could be the pre-printed gift icon or text on the card, surprising both giver and receiver.

17. The lottery scratch off game of claim 6, wherein it is printed on a postcard with separate instructions that reveal more than one option of what could be the pre-printed gift icon or text on the card, surprising both giver and receiver.

18. The lottery scratch off game of claim 6, wherein it is programmed to select an icon or word by chance, without the sender knowing the result of the game and what the receiver will win or see, and is sent electronically by eMail, social media message or text message and be played electronically within the eMail or social media program or text message.

19. The non-lottery scratch off game of claim 1, wherein it is programmed to select an icon or word by chance, without the sender knowing the result of the game and what the receiver will win or see, and is sent electronically by eMail, social media message or text message and be played when the receiver clicks and goes to a specific URL.
